(19) United States
(12) Patent Application Publication
(10) Pub. No.: US 2005/0180721 A1
(43) Pub. Date: Aug. 18, 2005

(54) Method for manufacturing electro-optic device, electro-optic device, and electronic apparatus

(75) Inventors: Kenji Hayashi, Suwa-shi (JP); Yasushi Karasawa, Shiojiri-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/004,082

(22) Filed: Dec. 6, 2004

(30) Foreign Application Priority Data
Feb. 6, 2004 (JP) 2004-031054

(51) Int. Cl. G02B 6/00

(52) U.S. Cl. 385/147

(57) ABSTRACT

To provide a method for manufacturing an electro-optic device capable of preventing the degradation of a light-emitting layer which occurs in a manufacturing process; an electro-optic device; and an electronic apparatus. In a method for manufacturing an electro-optic device having a first electrode, a second electrode, and an electro-optic layer which is provided therebetween and above a base body, the method has the steps of forming a light emitting-material protective layer covering the second electrode by a vacuum deposition method and forming an electrode protective layer covering the light emitting-material protective layer by a plasma film-forming method.

### BACKGROUND

The present invention relates to a method for manufacturing an electro-optic device, an electro-optic device, and an electronic apparatus.

In the field of electro-optic devices, one of objects is to improve the durability against oxygen, moisture, and the like. In an organic electroluminescent (hereinafter simply referred to as “organic El”) display device, which is one of the electro-optic devices, for example, due to the degradation of electro-optic materials (organic EL material, hole injection material, electron injection material, and the like) forming a light-emitting layer (electro-optic layer) caused by oxygen, moisture, and the like, and/or the increase in resistance of a cathode caused by oxygen, moisture, and the like, non-light-emitting regions, so-called dark spots, are generated, and consequently, a problem may arise in that the serviceable life as a light-emitting element is decreased.

In order to solve the problem described above, measures have been taken in which moisture and the like are blocked by fitting a glass or a metal lid on a substrate of the display device. In addition, in order to meet the trend toward larger screen size and smaller wall thickness of display devices, a technique called thin film sealing has been recently used, in which a cathode protective layer or a gas barrier layer, which is made of silicon nitride, silicon oxide, metal oxide, ceramic, or the like, is formed on a light-emitting element by a high density plasma vapor deposition method (such as ion plating, ECR plasma sputtering, ECR plasma CVD, surface wave plasma CVD, or ICP-CVD).

In particular, when a top-emission structure in which light emission is performed at the cathode side is used, since the transparency cannot be satisfactorily obtained only by using a metal cathode material, the thickness thereof must be decreased as small as possible, and as a result, the cathode resistance is inevitably increased. Accordingly, when a cathode protective layer having transparent and conductive properties is formed on the cathode using metal oxide such as ITO (indium tin oxide), high resistance of the cathode can be compensated for by the cathode protective layer. Since the material mentioned above must be formed at a low temperature into a dense layer having a low resistance and superior gas barrier properties so as not to adversely affect the organic light-emitting layer, the film formation must be performed by a high density plasma vapor deposition method.

[Patent Document 1] Japanese Unexamined Patent Application Publication No. 2001-284041

### SUMMARY

However, when the cathode protective layer or the gas barrier layer is formed using a plasma vapor deposition_method such as high density plasma vapor deposition method, since being conductive, energy of ions and electrons generated in plasma transmits the cathode and adversely affects an organic EL material forming a light-emitting layer, and as a result, a problem may arise in that the light-emitting layer is degraded.

The present invention was made in consideration of the situation described above, and an object of the present invention is to provide an electro-optic device capable of preventing a light-emitting layer from being degraded in a manufacturing process, a manufacturing method of the electro-optic device, and an electronic apparatus.

In the method for manufacturing an electro-optic device, the electro-optic device, and the electronic apparatus, according to the present invention, the following measures are taken in order to achieve the object described above.

According to a first aspect of the present invention, there is provided a method for manufacturing an electro-optic device (1) having an electro-optic layer (110) which is provided above a base body (200) and between a first electrode (23) and a second electrode (50). The method described above comprises the steps of: forming a light emitting-material protective layer (65) covering the second electrode by a vacuum deposition method; and forming an electrode protective layer (55) covering the light emitting-material protective layer by a plasma vapor deposition_method. According to this first aspect of the present invention, even in the manufacturing process, the resistance of the second electrode can be decreased by the electrode protective layer, and at the same time, the degradation of the electro-optic layer caused by high density plasma can be prevented by the light emitting-material protective layer; hence, an electro-optic device which vividly emits light can be obtained.

In addition, in accordance with a second aspect of the present invention, there is provided a method for manufacturing the electro-optic device (1) having the electro-optic layer (110) which is provided above the base body (200) and between the first electrode (23) and the second electrode (50), the method described above comprising the steps of forming the light emitting-material protective layer (65) covering the electro-optic layer by a vacuum deposition method; forming the second electrode covering the light emitting-material protective layer; and forming the electrode protective layer (55) covering the second electrode by a plasma vapor deposition method. According to this second aspect of the present invention, even in the manufacturing process, the oxidation of the second electrode can be prevented by the electrode protective layer, and at the same time, the degradation of the electro-optic layer can be prevented by the light emitting-material protective layer; hence, an electro-optic device which vividly emits light can be obtained.

In addition, when the method described above further comprises the step of forming a gas barrier layer (30) covering the second electrode (50), the electrode protective layer (55), and the light emitting-material protective layer (65), after the manufacturing process, the intrusion of oxygen and the like into the cathode and the electro-optic layer can be prevented for a long period of time. By the use of the light emitting-material protective layer (65), the degradation of the electro-optic layer can be prevented in forming the gas barrier layer (30).

In addition, when the second electrode (50) is formed by a vacuum deposition method, damage is hardly done to the electro-optic layer, and the second electrode and the light emitting-material protective layer can be formed by the same film-forming apparatus; hence, the manufacturing process can be prevented from being complicated, and at the same time, the manufacturing cost can also be decreased.

In accordance with a third aspect of the present invention, there is provided the electro-optic device (1) having the electro-optic layer (110) which is provided above the base body (200) and between the first electrode (23) and the second electrode (50). In this electro-optic device (1), there are provided the electrode protective layer (55) protecting the second electrode and the light emitting-material protective layer (65) having insulating properties for preventing the degradation of the electro-optic layer which occurs in forming the electrode protective layer. According to this third aspect of the present invention, since the oxidation of the second electrode and the degradation of the electro-optic layer can be prevented even in the manufacturing process, an electro-optic device which vividly emits light can be obtained.

For example, the structure may be formed in which the light emitting-material protective layer (65) is provided on the second electrode (50), and the electrode protective layer (55) is provided on the light emitting-material protective layer (65).

Alternatively, the structure may be formed in which the light emitting-material protective layer (65) is provided between the electro-optic layer (110) and the second electrode (50), and the electrode protective layer (55) is formed on the second electrode.

In addition, when the electrode protective layer (55) is formed of a conductive and transparent metal oxide, an EL display device having a so-called top emission structure can be obtained.

Furthermore, when formed of a metal fluoride, the light emitting-material protective layer (65) is sublimed at a relatively low temperature, and hence a thin film can be formed without giving any adverse influence onto the electro-optic layer. In addition, by the presence of this film, the electro-optic layer can be protected from plasma in the manufacturing process. For example, as the metal fluoride, lithium fluoride, zinc fluoride, iron fluoride, vanadium fluoride, or cobalt fluoride may be mentioned. In particular, the metal fluoride which is formed by ion bonding has a band gap of 3 eV or more and has preferable insulating properties. Hence, for example, in the case in which the electrode protective layer (55) is formed by a plasma growth method, when the light emitting-material protective layer (65) is formed using a metal fluoride which is formed by ion bonding, the degradation of the electro-optic layer (110) can be prevented which is caused by electrons or ions present in the plasma. Since a fluoride of an alkali metal or an alkaline earth metal is evaporated or sublimed at a low temperature as compared to that of an insulating material such as a ceramic, the light emitting-material protective layer (65) can be formed without degrading the electro-optic layer. In particular, since having a high light transmittance, a fluoride of an alkali metal or an alkaline earth metal can be most preferably used for the top emission structure.

In addition, when the gas barrier layer (30) covering the second electrode (50), the electrode protective layer (55), and the light emitting-material protective layer (65) is further provided, the intrusion of moisture and the like into the cathode and the electro-optic layer can be prevented for a long period of time. By the use of the light emitting-material protective layer (65), the degradation of the electro-optic layer can be prevented in forming the gas barrier layer (30).

According to a fourth aspect of the present invention, electronic apparatuses (1000, 1100, 1200, and 1300) each have the electro-optic device (1) formed by the manufacturing method in accordance with one of the first and the second aspect of the present invention or each have the electro-optic device (1) in accordance with the third aspect of the present invention. According to this fourth aspect of the present invention, since the degradation of the second electrode and the electro-optic layer can be prevented which occurs in the manufacturing process, an electronic apparatus can be obtained which is capable of displaying brilliant image for a long period of time.

### BRIEF DESCRIPTION OF THE DRAWINGS

FIG. 1 is a view showing a wiring structure of an EL display device;

FIG. 2 is a schematic view showing the structure of an EL display device;

FIG. 3 is a cross-sectional view taken along the line A-B in FIG. 2;

FIG. 4 is a cross-sectional view taken along the line C-D in FIG. 2;

FIG. 5 is an enlarged cross-sectional view of an important portion in FIG. 3;

FIG. 6 includes views sequentially showing steps of a method for manufacturing an El display device;

FIG. 7 includes views sequentially showing steps following the steps shown in FIG. 6;

FIG. 8 includes views sequentially showing steps following the steps shown in FIG. 7;

FIG. 9 is an enlarged cross-sectional view of an important portion of an EL display device according to a modified embodiment; and

FIG. 10 includes views showing electronic apparatuses.

### DETAILED DESCRIPTION OF EMBODIMENTS

Hereinafter, embodiments of a method for manufacturing an electro-optic device, an electro-optic device, and an electronic apparatus, which are according to the present invention, will be described with reference to figures. As the electro-optic device, an EL display device will be described using an organic electroluminescent (EL) material of electroluminescent materials which is one example of an electro-optic material.

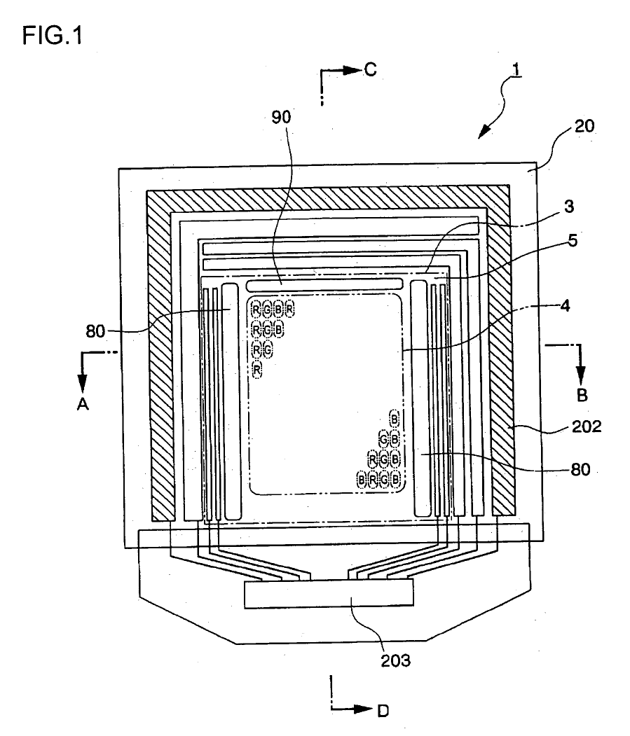

FIG. 1 is a view showing a wiring structure of an EL display device 1. The EL display device 1 is an active matrix EL display device in which thin film transistors (hereinafter referred to as “TFTs”) are used as switching elements.

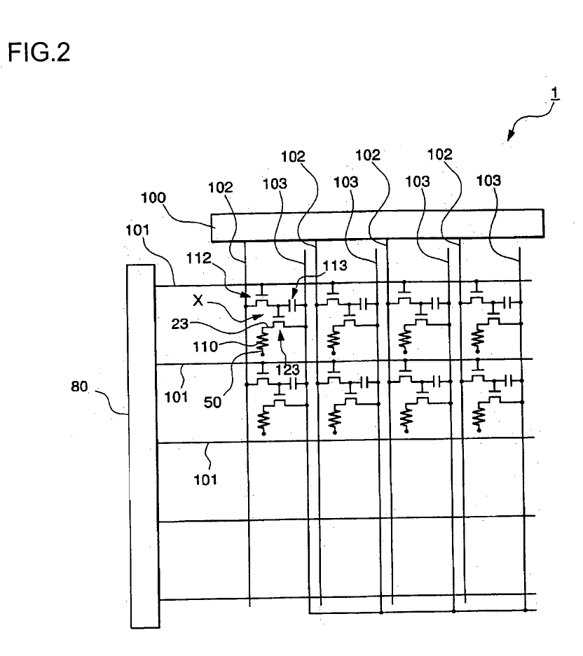

The EL display device (electro-optic device) 1 has the structure as shown in FIG. 2 in which a plurality of scanning lines 101, a plurality of signal lines 102 extending in the direction orthogonally intersecting the scanning lines 101, and a plurality of power lines 103 extending in parallel to the signal lines 102, and in addition, pixel regions X are provided in the vicinities of the intersecting points between the scanning lines 101 and the signal lines 102.

To the signal lines 102, a data line drive circuit 100 is connected which has a shift register, a level shifter, a video line, and an analog switch. In addition, to the scanning lines 101, scanning line drive circuits 80 are connected each having a shift register and a level shifter.

Furthermore, in each pixel region X, there are provided a switching TFT 112 which is supplied with a scanning signal at its gate electrode through the scanning line 101, a holding capacitor 113 which holds a pixel signal supplied from the signal line 102 through this switching TFT 112, a drive TFT 123 which is supplied with the pixel signal held by this holding capacitor 113 at its gate electrode, a pixel electrode (first electrode) 23 into which a drive current is supplied from the power line 103 when it is electrically connected thereto through this drive TFT 123, and an electro-optic layer 110 interposed between the pixel electrode 23 and a cathode (second electrode) 50. A light-emitting element (an organic EL element) is formed of the pixel electrode 23, the cathode 50, and the electro-optic layer 110.

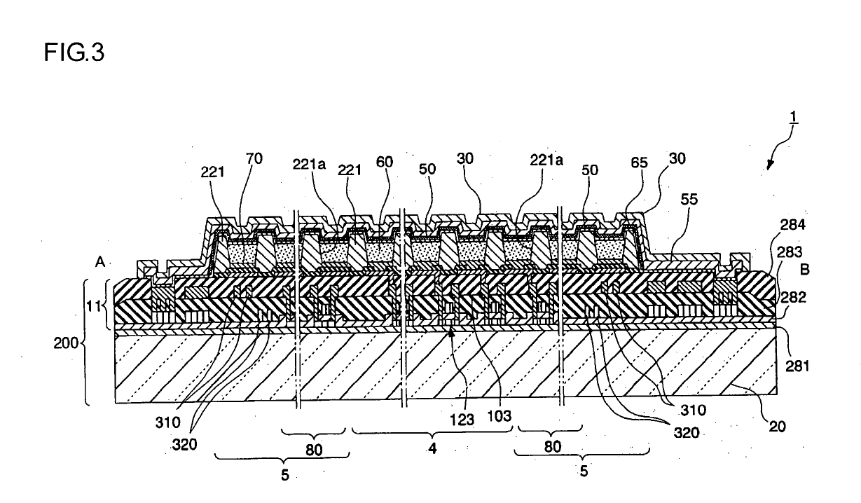

In the EL display device 1 described above, when the switching TFT 112 is driven through the scanning line 101 into an ON state, a potential of the signal line 102 is held in the holding capacitor 113, and in accordance with the state of this holding capacitor 113, the ON or OFF state of the drive TFT 123 is determined. Subsequently, current flows from the power line 103 to the pixel electrode 23 through the channel of the drive TFT 123 and further flows to the cathode 50 through the electro-optic layer 110. An organic light-emitting layer 60 (see FIG. 3) contained in the electro-optic layer 110 emits light in accordance with the amount of current flowing therethrough.

Next, a particular structure of the EL display device 1 will be described with reference to FIGS. 1 to 5. As shown in FIG. 1, this EL display device 1 has an active matrix structure composed of a substrate 20 having electrical insulating properties, a pixel electrode region (not shown) in which pixel electrodes connected to switching TFTs (not shown) are arranged in a matrix, power lines (not shown) disposed around the pixel electrode region and connected to the respective pixel electrodes, and a pixel portion 3 (enclosed by a chain line shown in FIG. 1) located at least on the pixel electrode region and having an approximately rectangular shape when viewed in plan view.

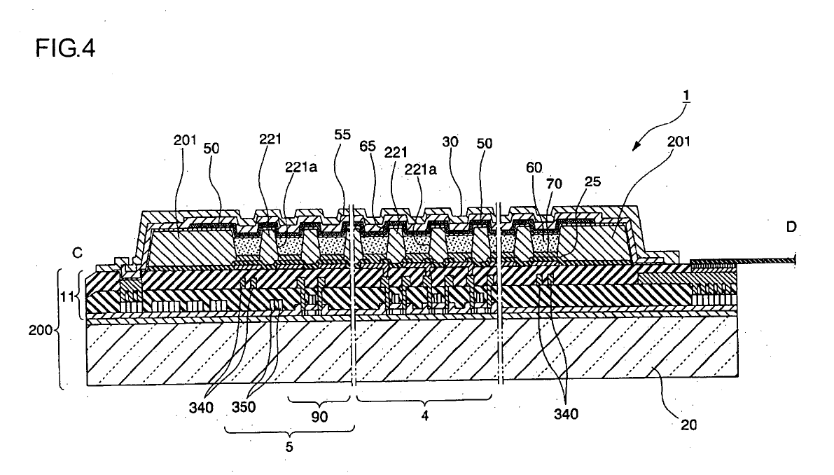

In the present invention, the substrate 20 and the switching TFTs, various types of circuits, and interlayer insulating films formed on the substrate 20 as described below are collectively called a base body (indicated by reference numeral 200 in FIGS. 3 and 4).

The pixel portion 3 is composed of an actual display region 4 (enclosed by a two-dot chain line in FIG. 1) located at the central portion and a dummy region 5 (between the chain line and the two-dot chain line) disposed around the actual display region 4.

In the actual display region 4, display regions R, G, and B each having a pixel electrode are disposed separately from each other in an A-B direction and a C-D direction to form a matrix.

In addition, at two sides of the actual display region shown in FIG. 1, scanning line drive circuits 80 are disposed. The scanning line drive circuits 80 are disposed under the dummy region 5.

Furthermore, at the upper side of the actual display region 4 shown in FIG. 1, an inspection circuit 90 is disposed. This inspection circuit 90 is a circuit for inspecting an operation state of the EL display device 1, the inspection circuit 90 having, for example, inspection data output means (not shown) for outputting inspection results so that quality and defect inspection of display device can be performed in manufacturing and before shipment. This inspection circuit 90 is also disposed under the dummy region 5.

The structure is formed so that drive voltages are applied to the scanning line drive circuits 80 and the inspection circuit 90 from predetermined power portions through drive voltage conduction portions 310 (see FIG. 3) and drive voltage conduction portions 340 (see FIG. 4). In addition, drive control signals and drive voltages are sent and applied to the scanning line drive circuits 80 and the inspection circuit 90 from a predetermined main driver or the like, which performs operational control of this EL display device 1, through drive control signal conduction portions 320 (see FIG. 3) and a drive voltage conduction portion 350 (see FIG. 4). The drive control signal in this case is a command signal from the main driver or the like relating to the control which will be performed when the scanning line drive circuits 80 and the inspection circuit 90 output signals.

In addition, as shown in FIGS. 3 and 4, the EL display device 1 has the structure in which a large number of light-emitting elements (organic EL elements) each provided with the pixel electrode 23, the organic light-emitting layer 60, and the cathode 50 are formed on the base body 200.

Furthermore, on the cathode 50, a light emitting-material protective layer 65 for preventing the degradation of the light-emitting material and a cathode protective layer 55 for preventing the oxidation of the cathode 50 are formed. In addition, a gas barrier layer 30 or the like is further formed thereon.

The organic light-emitting layer 60 (electroluminescent layer) is a major layer forming the electro-optic layer 110; however, between the two electrodes, a hole injection layer, a hole transport layer, an electron injection layer, an electron transport layer, a hole blocking layer, and an electron blocking layer may also be provided.

In the case of a so-called top emission EL display device, since light is emitted from the gas barrier layer 30 side, that is, from the side opposite to the substrate 20, as the substrate 20 forming the base body 200, both a transparent substrate and a non-transparent substrate may be used. As the non-transparent substrates, for example, there may be mentioned a ceramic such as alumina; a metal sheet such as stainless steel, which is processed by insulating treatment such as surface oxidation; a thermosetting and a thermoplastic resin; and a film (plastic film) thereof.

In addition, in the case of a so-called bottom emission EL display device, since light is emitted from the substrate 20 side, as the substrate 20, a transparent substrate or a semi-transparent substrate may be used. For example, there may be mentioned glass, quartz, and resin (plastic sheet, plastic film), and in particular, a glass substrate is preferably used. In this embodiment, a top emission structure is used in which light is emitted from the gas barrier layer 30 side.

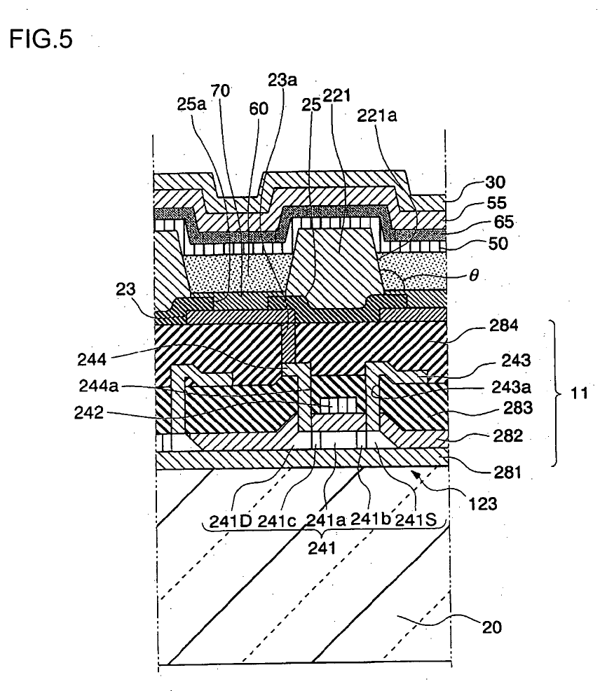

In addition, on the substrate 20, a circuit portion 11 including the drive TFTs 123 each driving the pixel electrode 23 is formed, and many light-emitting elements (organic El elements) are provided on the circuit portion 11. As shown in FIG. 5, the light-emitting element has the structure in which the pixel electrode 23 functioning as an anode, a hole transport layer 70 injecting/transporting electrons from the pixel electrode 23, the organic light-emitting layer 60 having an organic EL material which is one of the electro-optic materials, and the cathode 50 are formed in that order.

According to the structure as described above, in the organic light-emitting layer 60 of the light-emitting element, holes injected from the hole transport layer 70 and electrons from the cathode 50 are combined with each other, thereby emitting light.

The pixel electrode 23 is not necessary to be transparent since the top emission structure is used in this embodiment, and hence an optional conductive material may be used.

As a material for forming the hole transport layer 70, for example, a polythiophene derivative, a polypyrrole derivative, and a doped material thereof may be used. In particular, for example, a dispersion of 3,4-polyethylene dioxythiophene/polystyrene sulphonate (PEDOT/PSS) may be used.

As a material forming the organic light-emitting layer 60, a known light-emitting material which is able to emit fluorescence or phosphorescence may be used. In particular, for example, polyfluorene derivatives (PF), poly(paraphenylene vinylene) derivatives (PPV), polyphenylene derivatives (PP), polyparaphenylene derivatives (PPP), polyvinylcarbazole (PVK), polythiophene derivatives, and polysilane materials such as polymethylphenylsilane (PMPS) may be preferably used.

In addition, to the polymer materials mentioned above, polymer base materials, such as perylene base pigments, coumarin base pigments, and rhodamine base pigments, and low-molecular weight materials such as rublene, perylene, 9,10-diphenylanthracene, tetraphenylbutadiene, Neil Red, coumarin 6, quinacridone may be added as a doping material.

Instead of the aforementioned polymer materials, conventionally known low molecular weight materials may also be used.

In addition, whenever necessary, on the organic light-emitting layer 60, an electron injection layer of a metal or a metal compound, which is primarily composed of calcium, magnesium, lithium, sodium, strontium, barium, or cesium, may be formed.

In addition, the hole transport layer 70 and the organic light-emitting layer 60 of this embodiment are disposed so as to be surrounded by a lyophilic control layer 25 and an organic bank layer (bank structure body) 221, both of which have a grating shape formed on the base body 200 as shown in FIGS. 3 to 5, and the hole transport layer 70 and the organic light-emitting layer 60 thus surrounded serve as elemental layers collectively forming a single light-emitting element (organic EL element).

In addition, an angle θ of a wall surface of an opening portion 221a of the organic bank layer 221 is set in the range of 110 to 170° (see FIG. 5) with respect to the surface of the base body 200. The reason the angle is set as described above is that when formed by a wet process, the hole transport layer 70 and the organic light-emitting layer 60 are easily disposed in the opening portion 221a.

The cathode 50 has an area larger than the total area of the actual display region 4 and the dummy region 5 as shown in FIGS. 3 to 5 and is formed so as to cover the above two regions. That is, the cathode 50 is formed over the base body 200 so as to cover the upper surfaces of the organic light-emitting layers 60, the upper surface of the organic bank layer 221, and side wall surfaces forming the side portions of the organic bank layer 221. As shown in FIG. 4, this cathode 50 is connected to a cathode connection wire 202 formed outside of the organic bank layer 221 and along the periphery of the base body 200. A flexible substrate 203 is connected to this cathode connection wire 202, and hence the cathode 50 is connected to a drive IC (drive circuit) not shown in the figure through the cathode connection wire 202, the drive IC being provided on the flexible substrate 203.

As a material for forming the cathode 50, a material having light permeability must be used since the top emission structure is formed in this embodiment, and hence, for example, a thin film metal layer (or alloy layer) made of calcium (Ca), magnesium (Mg), silver (Ag), or aluminum (Al) is preferably used.

On the upper portion of the cathode 50, the light emitting-material protective layer 65 is provided. The light emitting-material protective layer 65 must have insulating properties and is a layer provided for preventing the degradation of the organic light-emitting layers 60 in manufacturing process which is caused by the transmission of high energy of ions and electrons generated in plasma.

As a material for forming the light emitting-material protective layer 65, a metal fluoride is preferably used. In particular, for example, lithium fluoride, magnesium fluoride, and sodium fluoride may be mentioned.

As described above, when the organic light-emitting layers 60 are covered with the light emitting-material protective layer 65 made of a metal fluoride, the transmission of high density plasma energy to the organic light-emitting layers 60 can be suppressed, and hence the degradation of the organic light-emitting material can be preferably prevented. In addition, the light emitting-material protective layer 65 is formed to have a thickness in the range of approximately 1 to 30 nm.

On the upper portion of the light emitting-material protective layer 65, the cathode protective layer 55 is provided. The cathode protective layer 55 is a layer provided for preventing corrosion of the cathode 50 in the manufacturing process and also serves as a layer for compensating for insufficient conductivity of the cathode 50 which is formed to have a small thickness. When the structure is formed in which the light emitting-material protective layer 65 is provided on the cathode 50, the degradation of the organic light-emitting layer 60 can be prevented without interfering with the injection of electrons from the cathode 50 to the organic light-emitting layer 60.

As a material for forming the cathode protective layer 55, a material having light permeability must be used since the EL display device 1 has a top emission structure, and hence, a transparent conductive material is used. In particular, ITO (indium tin oxide) is preferable; however, besides ITO, for example, an indium oxide/zinc oxide base amorphous transparent conductive film (indium zinc oxide, IZO (registered trade name)), aluminum zinc oxide (AZO), and tin oxide may also be used. In this embodiment, ITO is used. Since a dense film having low resistance must be formed at a low temperature, the materials mentioned above are formed into a film using a high density plasma vapor deposition method.

As described above, when the cathode 50 is covered with the cathode protective layer 55 made of a metal oxide film, the corrosion of the cathode 50 caused by oxygen, moisture, organic materials, and the like which are brought into contact with the cathode can be preferably prevented. In addition, the cathode protective layer 55 is formed to have a thickness in the range of approximately 10 to 300 nm.

Furthermore, over the cathode 50, the light emitting-material protective layer 65, and the cathode protective layer 55, the gas barrier layer 30 is provided.

The gas barrier layer 30 is a layer for preventing oxygen and moisture from entering the inside thereof, and by the presence of this barrier layer 30, the intrusion of oxygen and moisture into the cathode 50 and the organic light-emitting layers 60 are prevented, so that the degradation and the like of the cathode 50 and the organic light-emitting layers 60 are suppressed which are caused by oxygen and moisture.

In addition, the gas barrier layer 30 is formed, for example, of an inorganic material and is preferably formed of a silicon compound such as silicon nitride, silicon oxynitride, or silicon oxide by a high density plasma vapor deposition method. However, besides the silicon compounds, for example, alumina, tantalum oxide, titanium oxide, and another ceramic may also be used. When the gas barrier layer 30 is formed by a plasma vapor deposition method as is the case of the cathode protective layer 55, by the use of the light emitting-material protective layer 65, the degradation of the electro-optic layer which occurs in forming the gas barrier layer 30 can be prevented.

In addition, between the organic light-emitting layer 60 and the cathode 50, a layer may be further formed using the material mentioned for the light emitting-material protective layer 65. By the layer described above, the degradation of the electro-optic layer which occurs when the gas barrier layer 30 or the cathode protective layer 55 is formed can be further prevented.

In addition, as the gas barrier layer 30, for example, a two-layered structure composed of an organic resin layer and a silicon compound and a laminate structure containing a silicon compound and a non-silicon material, such as silicon nitride and ITO, may be used. When an underlayer is formed using an inorganic material as described above, for example, the adhesion is improved, the stress is reduced, and the density of the gas barrier layer made of a silicon compound can be improved.

The thickness of the gas barrier layer 30 as described above is preferably in the range of 10 to 500 nm. The reason for this is that when the thickness is less than 10 nm, since some through-holes may be unintentionally formed in the layer due to the defect of the film or the variation in thickness thereof, the gas barrier properties are degraded. On the contrary, when the thickness is more than 500 nm, cracking may occur in the layer in some cases due to stress generated therein.

In addition, since the top emission structure is used in this embodiment, the gas barrier layer 30 must have light permeability, and hence the light transmittance in the visible light region is set, for example, to 80% or more in this embodiment by optionally controlling the material and the thickness of the layer.

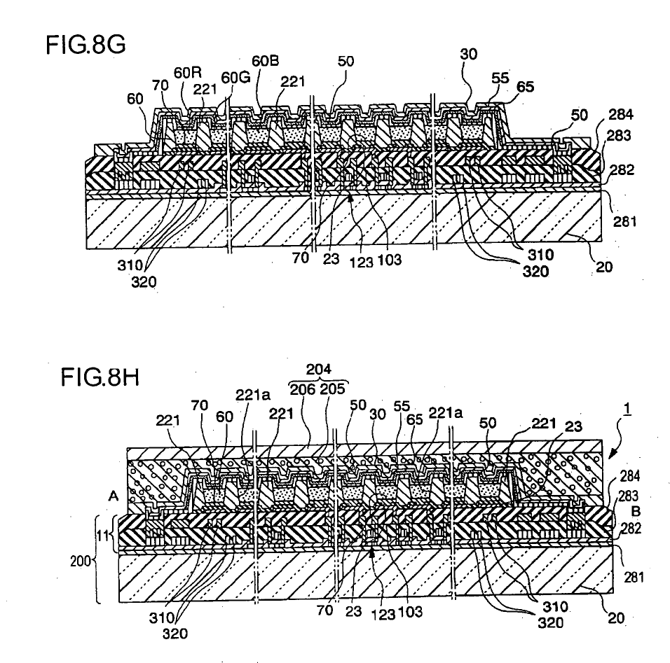

Furthermore, outside the gas barrier layer 30, a protective layer 204 covering the gas barrier layer 30 is provided (see FIG. 8(h)). This protective layer 204 is formed of an adhesive layer 205 provided at the gas barrier layer 30 side and a surface protective layer 206.

The adhesive layer 205 is a layer fixing the surface protective layer 206 above the gas barrier layer 30 and having a buffer function against a mechanical impact done thereto from the outside and is composed, for example, of urethane, acrylic, epoxy, or polyolefin resin. In addition, the adhesive layer 205 is formed of an adhesive which has flexibility and a low glass transition temperature as compared to those of the surface protective layer 206 described below. To the adhesive described above, a silane coupling agent or alkoxysilane is preferably added, and by the addition described above, the adhesion between the adhesive layer 205 thus formed and the gas barrier layer 30 is further improved, and as a result, the buffer function against a mechanical impact can be enhanced.

In particular, when the gas barrier layer 30 is formed of a silicon compound, the adhesion therewith can be improved by the use of a silane coupling agent or alkoxysilane, and accordingly, the gas barrier properties of the gas barrier layer 30 can be enhanced.

The surface protective layer 206 is provided on the adhesive layer 205 to form the surface side of the protective layer 204 and is a layer having at least one function among pressure resistance, abrasion resistance, exterior-light antireflection properties, gas barrier properties, UV blocking properties, and the like. In particular, the surface protective layer 206 is formed of a glass substrate or a plastic film having a DLC (diamond like carbon) layer, a silicon oxide layer, a titanium oxide layer, or the like applied onto its topmost surface.

In addition, both the surface protective layer 206 and the adhesive layer 205 must have light permeability when the top emission structure is used in the EL display device of this embodiment; however, when the bottom emission structure is used, the light permeability is not necessary.

Under the light-emitting elements described above, the circuit portion 11 is provided as shown in FIG. 5. This circuit portion 11 is provided on the substrate 20 to form the base body 200. That is, on the surface of the substrate 20, an underlying protective layer 281 primarily made of SiO₂ is formed, and a silicon layer 241 is formed thereon. On the surface of this silicon layer 241, a gate insulating layer 282 primarily made of SiO₂ and/or SiN is formed.

In addition, a part of the silicon layer 241 overlapping a gate electrode 242 with the gate insulating layer 282 interposed therebetween is a region to be used as a channel region 241a. In addition, the gate electrode 242 is a part of the scanning line 101 not shown in the figure. On the surface of the gate insulating layer 282 which covers the silicon layer 241 and which is provided with the gate electrode 242, a fist interlayer insulating layer 283 primarily composed of SiO₂ is formed.

In addition, in the silicon layer 241, a lightly doped source region 241b and a heavily doped source region 241S are provided at the source side of the channel region 241a, and a lightly doped drain region 241c and a heavily doped drain region 241D are provided at the drain side of the channel region 241a, thereby forming a so-called LDD (lightly doped drain) structure. Among the regions mentioned above, the heavily doped source region 241S is connected to a source electrode 243 via a contact hole 243a formed through the gate insulating layer 282 and the first interlayer insulating layer 283. This source electrode 243 is formed as a part of the power line 103 described above (see FIG. 2; in FIG. 5, the power line 103 extends in the direction perpendicular to the plane of the figure at the position of this source electrode 243). In addition, the heavily doped drain region 241D is connected to a drain electrode 244 made of the same layer as that for the source electrode 243 via a contact hole 244a formed through the gate insulating layer 282 and the first interlayer insulating layer 283.

The upper surface of the first interlayer insulating layer 283 on which the source electrode 243 and the drain electrode 244 are formed is covered with a second interlayer insulating layer 284 primarily composed of a silicon compound, such as silicon nitride, silicon oxide, or silicon oxynitride, having gas barrier properties. The second interlayer insulating layer 284 may be a single layer formed of a silicon compound such as silicon nitride (SiN) or silicon oxide (SiO₂) or may be formed in combination with a wire planarizing layer made of an acrylic resin or the like. In addition, the pixel electrode 23 made of ITO is formed on the surface of this second interlayer insulating layer 284 and is simultaneously connected to the drain electrode 244 through a contact hole 23a formed in the second interlayer insulating layer 284. That is, the pixel electrode 23 is connected to the heavily doped drain region 241D of the silicon layer 241 through the drain electrode 244.

Each of TFTs (drive circuit TFTs) included in the scanning line drive circuits 80 and the inspection circuit 90, that is, for example, an n-channel or a p-channel TFT forming an inverter in the shift register of the drive circuit described above has the same structure as that of the drive TFT 123 except that the pixel electrode 23 is not connected to the TFT described above.

On the surface of the second interlayer insulating layer 284 provided with the pixel electrodes 23 thereon, the lyophilic control layer 25 and the organic bank layer 221, which are described above, are provided in addition to the pixel electrodes 23. The lyophilic control layer 25 is primarily formed of a lyophilic material such as SiO₂, and the organic bank layer 221 is formed of an acrylic or a polyimide resin. In addition, on the pixel electrode 23, the hole transport layer 70 and the organic light-emitting layer 60 are provided in that order in an opening portion 25a formed in the lyophilic control layer 25 and in the opening portion 221a surrounded by the organic bank layer 221. The “lyophilic property” of the lyophilic control layer 25 according to this embodiment indicates that the lyophilic property thereof is at least superior to that of the material such as an acrylic or a polyimide resin forming the organic bank layer 221.

The layers from the layer located on the substrate 20 to the second interlayer insulating layer 284 collectively form the circuit portion 11.

In the EL display device 1 of this embodiment, for performing color display, the individual organic light-emitting layers 60 are formed so that emission wavelength regions correspond to the three primary colors of light. For example, as the organic light-emitting layers 60, a red organic light-emitting layer 60R having an emission wavelength region which corresponds to a red color, a green organic light-emitting layer 60G having an emission wavelength region which corresponds to a green color, and a blue organic light-emitting layer 60R having an emission wavelength region which corresponds to a blue color are provided at respective display regions R, G, and B, and the display regions R, G, and B collectively form one pixel for performing color display. In addition, along the boundaries between the individual color regions, a BM (black matrix) not shown in the figure is formed, for example, between the organic bank layer 221 and the lyophilic control layer 25 by sputtering or the like using chromium metal.

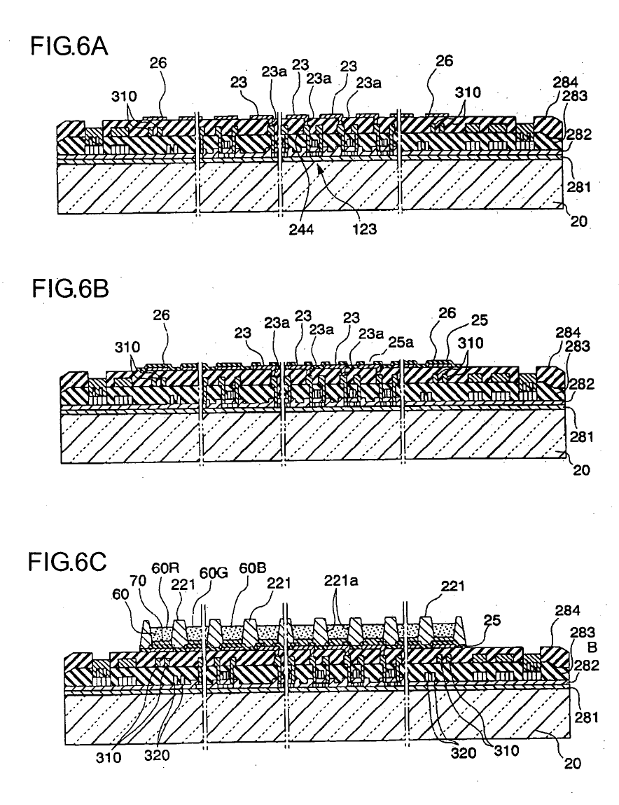

Next, one example of a method for manufacturing the EL display device 1 of the present invention will be described with reference to FIGS. 6 to 8. The cross-sectional views shown in FIGS. 6 to 8 correspond to the cross-sectional view taken along the line A-B shown in FIG. 1.

In this embodiment, the EL display device 1 as the electro-optic device has a top emission structure, and in addition, since the steps for forming the circuit portion 11 on the surface of the substrate 20 are the same as those of a conventional technique, the description thereof will be omitted.

First, as shown in FIG. 6(a), a conductive film to be formed into the pixel electrodes 23 is formed to cover the entire surface of the substrate 20 provided with the circuit portion 11 on the surface thereof, and furthermore, by patterning this transparent conductive film, the pixel electrodes 23 connected to the respective drain electrodes 244 through the contact holes 23a of the second interlayer insulating layer 284 are formed, and at the same time, the dummy patterns 26 are also formed in the dummy region.

In FIGS. 3 and 4, the pixel electrodes 23 and the dummy patterns 26 are each referred to as the pixel electrode 23. The dummy pattern 26 is formed so as not to be connected to the metal wire provided at the lower side through the second interlayer insulating layer 284. That is, the dummy pattern 26 is disposed to have an island shape, and the shape thereof is approximately equivalent to that of the pixel electrode 23 formed in the actual display region. Of course, the dummy pattern 26 may have a shape different from that of the pixel electrode 23. In the case described above, patterns located at least over the drive voltage conduction portions 310 (340) may also be regarded as the dummy patterns 26.

Next, as shown in FIG. 6(b), the lyophilic control layer 25 which is an insulating layer is formed on the pixel electrodes 23, the dummy patterns 26, and the second interlayer insulating layer. On the pixel electrodes 23, the lyophilic control layer 25 is formed so as to have openings, and hence the hole transportation from the pixel electrodes 23 can be performed through the opening portions 25a (see FIG. 3). On the contrary, at the dummy patterns 26 provided with the lyophilic control layer 25 which has no opening portions 25a, the hole transportation are not generated since the insulating layer (lyophilic control layer) 25 serves as a hole transport blocking layer. Subsequently, the BM (black matrix) not shown in the figure is formed in a concave portion of the lyophilic control layer 25 formed between adjacent pixel electrodes 23. In particular, in the concave portion formed in the lyophilic control layer 25, a film is formed by sputtering using metal chromium.

Next, as shown in FIG. 6(c), the organic bank layer 221 is formed at a predetermined position on the lyophilic control layer 25, and more particularly, is formed so as to cover the BM described above. As a particular method for forming the organic bank layer, for example, a method may be mentioned in which a solution containing a resist made of an acrylic or a polyimide resin dissolved in a solvent is applied by one of various coating techniques such as spin coating and slit die coating to form an organic layer. Any material may be used for forming the organic layer as long as being insoluble in a solvent used for ink which will be described below and being easily patterned by etching or the like.

Furthermore, by forming the opening portions 221a in the organic layer using a photographic and an etching technique, the organic bank layer 221 is formed which is provided with the opening portions 221a having wall surfaces. In this step, the side surface of the opening portion 221a is formed to have an angle of 110 to 170° with respect to the surface of the base body 200.

In the case described above, layers located at least over the drive control signal conduction portions 320 may also be regarded as the organic bank layer 221.

Next, a region having lyophilic properties and a region having lyophobic properties are formed. In this embodiment, the individual regions are formed by plasma treatment. In particular, the plasma treatment has the steps of performing a pre-heating step; an ink-philic imparting step of imparting lyophilic properties to the upper surface of the organic bank layer 221, the wall surfaces of the opening portions 221a, electrode surfaces 23c of the pixel electrodes 23, and the upper surface of the lyophilic control layer 25; an ink-phobic imparting step of imparting lyophobic properties to the upper surface of the organic bank layer 221 and the wall surfaces of the opening portions 221a; and a cooling step.

That is, a base material (the substrate 20 including the bank and the like) is heated to a predetermined temperature, such as approximately 70 to 80° C., followed by plasma treatment (O₂ plasma treatment) performed in the atmosphere as the ink-philic imparting step in which oxygen is used as a reactant gas. Next, as the ink-phobic imparting step, plasma treatment (CF₄ plasma treatment) is performed in the atmosphere in which tetrafluoromethane is used as a reactant gas, and subsequently, the base material thus heated for the plasma treatment was cooled to room temperature, thereby imparting the lyophilic and the lyophobic properties to the predetermined positions.

This CF₄ plasma treatment may have some influence over the electrode surfaces 23c of the pixel electrodes 23 and the lyophilic control layer 25; however, since ITO which is used for forming the pixel electrode 23 and SiO₂, TiO₂, and the like which are used for forming the lyophilic control layer 25 have small affinity for fluorine, hydroxides formed in the ink-philic imparting step are not substantially replaced with fluorine, and hence the lyophilic properties can be retained.

Next, by a hole transport-layer forming step, the hole transport layer 70 is formed. In this hole transport-layer forming step, a hole transport-layer material is applied onto the electrode surface 23c by a liquid droplet jetting method such as an ink-jet method or a slit die coating method, and drying and heating treatment are then performed, thereby forming the hole transport layer 70 on the electrode 23. In the case in which the hole transport-layer material is selectively applied by an ink-jet method, first, the hole transport-layer material is filled in an ink-jet head (not shown), a discharge nozzle of the ink-jet head is placed to face the electrode surface 23c located in the opening portion 25a formed in the lyophilic control layer 25, and subsequently, while the ink-jet head and the base material (substrate 20) are relatively moved, a liquid droplet is discharged from the discharge nozzle to the electrode surface 23c, the amount per liquid droplet being controlled. Next, the liquid droplet thus discharged is processed by drying treatment so that a dispersion medium or a solvent contained in the hole transport-layer material is evaporated, thereby forming the hole transport layer 70.

In this process, the liquid droplet thus discharged from the discharge nozzle spreads on the electrode surface 23c processed by the lyophilic treatment and fill the opening portion 25a formed in the lyophilic control layer 25. On the contrary, the liquid droplet is repelled on the upper surface of the organic bank layer 221 processed by the ink-phobic treatment and is not adhered thereto. Hence, even when the liquid droplet deflects from a predetermined discharge position to the upper surface of the organic bank layer 221, the upper surface thereof is not wetted with this liquid droplet, and the liquid droplet thus repelled falls into the opening portion 25a formed in the lyophilic control layer 25.

In order to prevent the oxidation of the hole transport layer 70 and the organic light-emitting layer 60, a process from this hole transport-layer forming step is preferably performed in a nitrogen or an argon atmosphere.

Next, by a light emitting-layer forming step, the organic light-emitting layer 60 is formed. In this light emitting-layer forming step, a light emitting-layer material is discharged onto the hole transport layer 70 by an ink-jet method or the like, followed by drying and heating treatment, thereby forming the organic light-emitting layer 60 in the opening portion 221a formed in the organic bank layer 221. In this light emitting-layer forming step, in order to prevent re-dissolution of the hole transport layer 70, as a solvent for the light emitting-layer material, a non-polar solvent in which the hole transport layer 70 is insoluble is used.

In this light emitting-layer forming step, for example, a light emitting-layer material having a blue (B) color is selectively applied onto blue display regions by an ink-jet method and is then dried, and subsequently, in the same manner as described above, a light emitting-layer material having a green (G) color and that having a red (R) color are applied onto respective display regions, followed by drying.

In addition, whenever necessary, on the organic light-emitting layer 60 described above, an electron injection layer may be formed by a deposition method or the like using a metal or a metal compound which is primarily composed of calcium, magnesium, lithium, sodium, strontium, barium, or cesium.

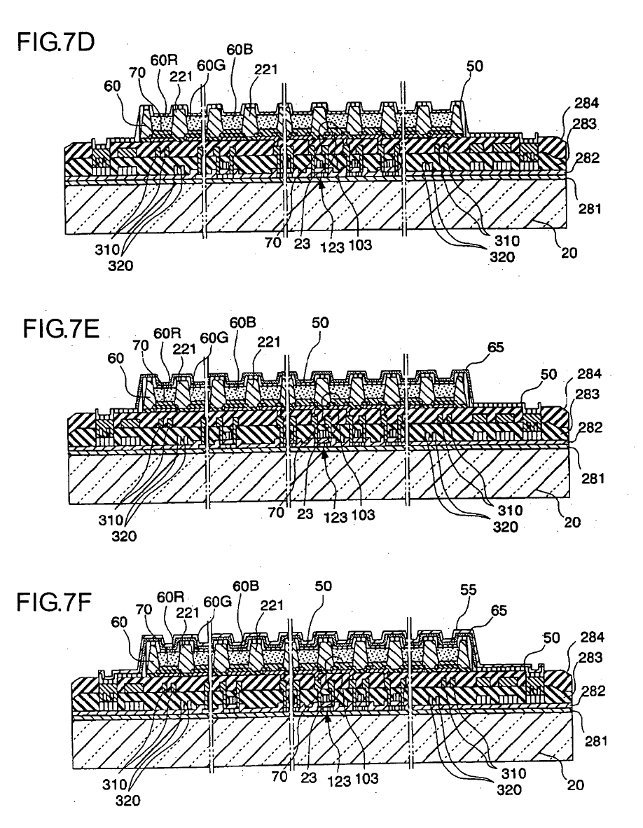

Next, as shown in FIG. 7(d), by a cathode-layer forming step, the cathode 50 is formed. In this cathode-layer forming step, using vacuum deposition by resistive heating or the like, a single-layered or a double-layered film is formed as the cathode 50 from a metal such as aluminum, magnesium, silver, or calcium, or an alloy thereof. In this step, this cathode 50 is formed so as to cover the outside portions of the organic bank 221 in addition to the upper surfaces of the organic light-emitting layers 60 and the upper surface of the organic bank layer 221.

The resistive heating vacuum deposition method is one of thin film-forming methods, in which a material to be formed into a thin film is placed in a heating boat or a crucible and is then heated in an approximately vacuum state to a relatively low temperature, such as approximately 200 to 1,000° C., so that the vapor of the material is allowed to adhere onto a substrate surface. Since the processing temperature is low, damage done to the light-emitting material is small, and in particular, since plasma and electron beams are not generated, the degradation of the organic light-emitting material can be suppressed.

Next, as shown in FIG. 7(e), the light emitting-material protective layer 65 is formed. Also in this step, by a resistive heating vacuum deposition method, a film of a metal fluoride such as lithium fluoride, magnesium fluoride, sodium fluoride, zinc fluoride, iron fluoride, vanadium fluoride, or cobalt fluoride is formed as the light emitting-material protective layer 65. As is the case of the cathode 50, since the light emitting-material protective layer 65 is formed by a resistive heating vacuum deposition method, the degradation of the light-emitting material can be suppressed. In addition, since the same film forming apparatus can be used, the manufacturing process is not complicated, and the manufacturing cost can be reduced.

In particular, a metal fluoride, which is formed by ion bonding, has a band gap of 3 eV or more and has superior insulating properties. Since a fluoride of an alkali metal or an alkaline earth metal can be evaporated or sublimed at a relatively low temperature as compared to that of a ceramic insulating material such as silicon oxide or alumina, the light emitting-material protective layer 65 can be formed without degrading the electro-optic layer. In particular, since having a high light transmittance, a fluoride of an alkali metal or an alkaline earth metal can be most preferably used for the top emission structure. As the fluoride of an alkali metal or an alkaline earth metal, for example, lithium fluoride, magnesium fluoride, or sodium fluoride may be mentioned.

Next, as shown in FIG. 7(f), on the light emitting-material protective layer 65, a thin film of ITO or the like is formed as the cathode protective layer 55 by a high density plasma film forming method.

In this step, since the light emitting-material protective layer 65 is already formed above the upper surfaces of the organic light-emitting layers 60, the organic light-emitting layers 60 can be protected from plasma generated in forming the cathode protective layer 55, thereby preventing the degradation of the light-emitting material. Hence, a light-emitting device capable of vividly emitting light can be obtained.

Next, as shown in FIG. 8(g), the gas barrier layer 30 is formed over the cathode 50, the light emitting-material protective layer 65, and the cathode protective layer 55 so as to cover all the parts of the cathode 50 exposed on the base body 200.

In this step, as a method for forming this gas barrier layer 30, a film of silicon compound such as silicon nitride is formed by a high density plasma film forming method. Also in this step, the organic light-emitting layers 60 can be protected from plasma generated in forming the gas barrier layer 30 by the light emitting-material protective layer 65, thereby preventing the degradation of the light-emitting material. Hence, a light-emitting device capable of vividly emitting light can be obtained.

The gas barrier layer 30 maybe formed to have a single-layered structure using a silicon compound as described above or may be formed to have a multilayer structure which contains a silicon compound and a material different therefrom. Furthermore, even when the single-layered structure is formed, the composition thereof may be continuously or discontinuously changed along the thickness direction.

Subsequently, as shown in FIG. 8(h), on the gas barrier layer 30, the protective layer 204 composed of the adhesive layer 205 and the surface protective layer 206 is provided. The adhesive layer 205 is approximately uniformly applied onto the gas barrier layer 30 by a screen printing or a slit die coating method, and the surface protective layer 206 is adhered thereon.

As described above, when the protective layer 204 is provided on the gas barrier layer 30, since the surface protective layer 206 has pressure resistance, abrasion resistance, antireflection properties, gas barrier properties, UV blocking properties, and/or the like, in addition to the organic light-emitting layers 60 and the cathode 50, the gas barrier layer 30 is also protected by this surface protective layer 206. Accordingly, the serviceable life of the light-emitting element can be increased.

In addition, since the adhesive layer 205 has a buffer function against a mechanical impact, when an exterior mechanical impact is applied, the damage done to the gas barrier layer 30 or the light-emitting element placed at the inside thereof can be reduced, and as a result, the degradation of functions of the light-emitting element can be prevented which is caused by this mechanical impact.

Incidentally, fine particles 207 may be contained in the adhesive layer 205. When being contained in the adhesive layer 205, the fine particles 207 serve as spacers, and hence the thickness of the adhesive layer 205 can be approximately uniformly formed.

As described above, the EL display device 1 is formed.

In Table 1, the ratio of luminance and the ratio of light-emitting efficiency of the organic light-emitting layer 60 are shown, each of the ratios being obtained between the cases with and without using the light emitting-material protective layer 65.

TABLE 1
Luminance and Light-Emitting Efficiency of Organic
Light-Emitting Layer at Voltage of 4V

| | | Ratio of |
|---|---|---|
| | | Light- |
| | Ratio of | Emitting |
| | Luminance | Efficiency |
| | (%) | (%) |
| With Light Emitting-Material Protective | 100 | 100 |
| Layer (Embodiment) (Organic Light-Emitting | | |
| Layer/Electron Injection Layer/Cathode/Light | | |
| Emitting-Material Protective Layer/ | | |
| Cathode Protective Layer) | | |
| Without Light Emitting-Material Protective | 75 | 60 |
| Layer (Organic Light-Emitting Layer/ | | |
| Electron Injection Layer/Cathode/ | | |
| Cathode Protective Layer) | | |
| Without Cathode Protective Layer (Reference) | 100 | 100 |
| (Organic Light-Emitting Layer/Electron | | |
| Injection Layer/Cathode) | | |

Unit: Luminance, Cd/m²; Light-Emitting Efficiency, Lm/W

In particular, the luminance and light-emitting efficiency were measured when a red color was turned on by using a display device containing an ITO film (indium tin oxide 150 nm thick) as the cathode protective layer 55 which was formed by an ECR plasma sputtering apparatus, and the ratios described above were calculated from the measurement results obtained with or without using the light emitting-material protective layer 65 (lithium fluoride 20 nm thick).

As shown in Table 1, when the light emitting-material protective layer 65 is not formed (organic light-emitting layer 60/electron injection layer/cathode 50/cathode protective layer 55 provided in that order), the decreases in luminance and light-emitting efficiency are apparent. That is, it is understood that energy of ions and electrons in plasma generated in forming the cathode protective layer 55 adversely affects the organic EL material forming the organic light-emitting layer 60.

On the other hand, in the case in which the light emitting-material protective layer 65 is formed (organic light-emitting layer 60/electron injection layer/cathode 50/light emitting-material protective layer 65/cathode protective layer 55 provided in that order), that is, according to the embodiment of the present invention, plasma generated in forming the cathode protective layer 55 is blocked by the light emitting-material protective layer 65, and as a result, it is understood that the luminance and light-emitting efficiency of the organic light-emitting layer 60 can be prevented from being decreased. In addition, when the light emitting-material protective layer 65 is formed, the state can be obtained in which the luminance and the light-emitting efficiency are approximately equivalent to those obtained when the cathode protective layer 55 is not formed (organic light-emitting layer 60/electron injection layer/cathode 50 provided in that order). That is, the state can be obtained which is approximately equivalent to that in which plasma is not generated in the manufacturing process.

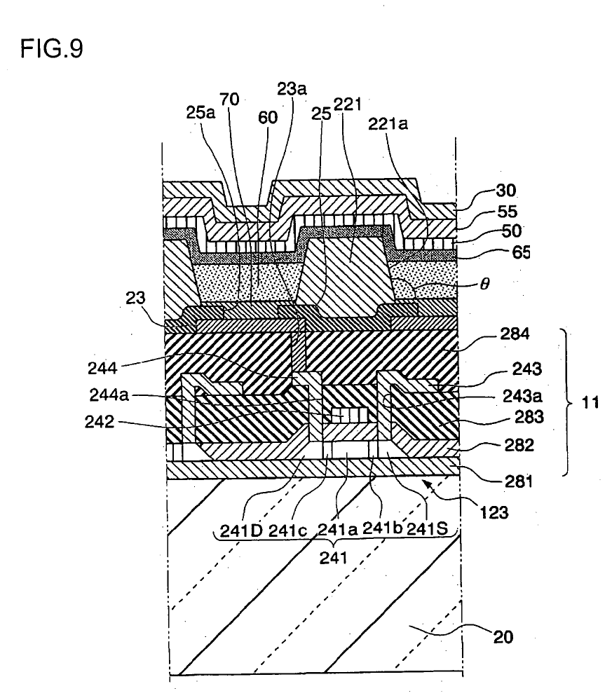

In the embodiment described above, the electro-optic layer 110 (organic light-emitting layer 60), the cathode 50, the light emitting-material protective layer 65, and the cathode protective layer 55 are formed in that order; however, the electro-optic layer 110 (organic light-emitting layer 60), the light emitting-material protective layer 65, the cathode 50, and the cathode protective layer 55 may be formed in that order. That is, as shown in FIG. 9, on the electro-optic layer 110 (organic light-emitting layer 60), the light emitting-material protective layer 65 may be directly formed.

In the embodiment described above, the EL display device 1 having a top emission structure is described by way of example; however, the present invention is not limited thereto and may be applied to a bottom emission structure or the structure in which light is emitted to two sides.

In addition, when the bottom emission structure or the structure in which light is emitted to two sides is used. The switching TFT 112 and the drive TFT 123 provided for the base body 200 are preferably formed under the lyophilic control layer 25 and the organic bank layer 221 instead of under the light-emitting element so as to increase the open area ratio.

In addition, in the EL display device 1 of the present invention, the first electrode is used as the anode, and the second electrode is used as the cathode; however, the first electrode and the second electrode may be used oppositely. That is, the first electrode and the second electrode may be used as the cathode and the anode, respectively. In the case described above, the positions at which the organic light-emitting layer 60 and the hole transport layer 70 are to be formed must be exchanged.

In addition, in this embodiment, the EL display device 1 is described as the electro-optic device by way of example; however, the present invention is not limited thereto and may be applied to any electro-optic device as long as it has the structure in which the second electrode is basically formed outside of the base body.

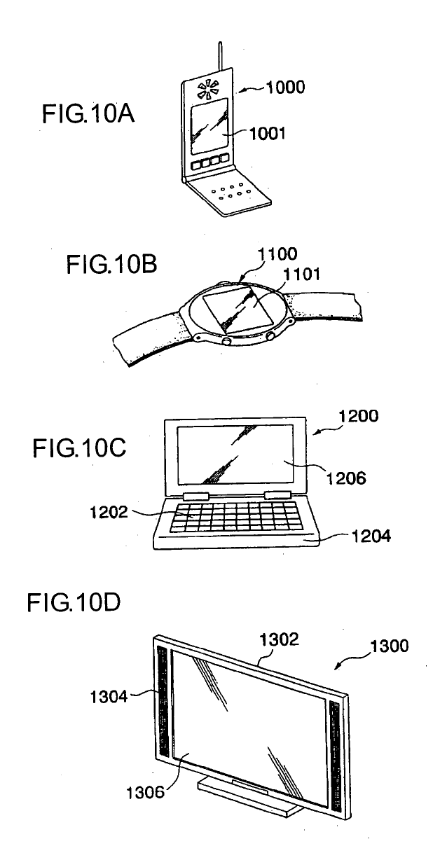

Next, electronic apparatuses of the present invention will be described. The electronic apparatuses each have the EL display device (electro-optic device) 1 described above as a display portion, and in particular, the apparatuses shown in FIG. 10 may be mentioned by way of example.

FIG. 10(a) is a perspective view showing an example of a mobile phone. In FIG. 10(a), a mobile phone (electronic apparatus) 1000 has a display portion 1001 formed of the EL display device 1 described above.

FIG. 10(b) is a perspective view showing an example of a wristwatch type electronic apparatus. In FIG. 10(b), a watch (electronic apparatus) 1100 has a display portion 1101 formed of the EL display device 1 described above.

FIG. 10(c) is a perspective view showing an example of a portable information processing apparatus such as a word processor or a personal computer. In FIG. 10(c), an information processing apparatus (electronic apparatus) 1200 has an input portion 1202 such as a keyboard, a display portion 1206 formed of the EL display device 1 described above, and an information processing main body (housing) 1204.

FIG. 10(d) is a perspective view showing an example of a thin and large-screen television. In FIG. 10(d), a thin and large-screen television (electronic apparatus) 1300 has a thin and large-screen television body (housing) 1302, a voice output portion 1304 such as a speaker, and a display portion 1306 formed of the EL display device 1 described above.

Since the electronic apparatuses shown in FIGS. 10(a) to 10(c) are provided with the display portions 1001, 1101, and 1206, respectively, each formed of the EL display device (electro-optic device) 1 described above, the light-emitting element of the EL display device forming the display portion has a longer serviceable life.

In addition, since the present invention in which the EL display device 1 can be sealed regardless of the area of the display portion 1306 is applied to the electronic apparatus shown in FIG. 10(d), the display portion (electro-optic device) 1306 has a large area (for example, having a width across corner of 20 inches or more) as compared to that of a conventional display portion.

1. A method for manufacturing an electro-optic device comprising a base body, a first electrode, a second electrode, and an electro-optic layer which is provided above the base body and between the first electrode and the second electrode, the method comprising the steps of:
forming a light emitting-material protective layer covering the second electrode by a vacuum deposition method; and
forming an electrode protective layer covering the light emitting-material protective layer by a plasma vapor deposition method.

2. A method for manufacturing an electro-optic device comprising a base body, a first electrode, a second electrode, and an electro-optic layer which is provided above the base body and between the first electrode and the second electrode, the method comprising the steps of:
forming a light emitting-material protective layer covering the electro-optic layer by a vacuum deposition method;
forming the second electrode covering the light emitting-material protective layer; and
forming an electrode protective layer covering the second electrode by a plasma vapor deposition method.

3. The method for manufacturing an electro-optic device according to claim 1, further comprising the step of forming a gas barrier layer covering the second electrode, the electrode protective layer, and the light emitting-material protective layer.

4. The method for manufacturing an electro-optic device according to claim 1, wherein the second electrode is formed by a vacuum deposition method.

5. An electro-optic device having a base body, a first electrode, a second electrode, and an electro-optic layer which is provided above the base body and between the first electrode and the second electrode, comprising:
an electrode protective layer protecting the second electrode; and
a light emitting-material protective layer having insulating properties for preventing the degradation of the electro-optic layer which occurs in forming the electrode protective layer.

6. The electro-optic device according to claim 5, wherein the light emitting-material protective layer is disposed on the second electrode, and the electrode protective layer is provided on the light emitting-material protective layer.

7. The electro-optic device according to claim 5, wherein the light emitting-material protective layer is disposed between the electro-optic layer and the second electrode, and the electrode protective layer is provided on the second electrode.

8. The electro-optic device according to claim 5, wherein the electrode protective layer comprises a conductive and transparent metal oxide.

9. The electro-optic device according to claim 5, wherein the light emitting-material protective layer comprises a metal fluoride.

10. The electro-optic device according to claim 9, wherein the metal fluoride is lithium fluoride.

11. The electro-optic device according to claim 5, further comprising a gas barrier layer covering the second electrode, the electrode protective layer, and the light emitting-material protective layer.

12. An electronic apparatus comprising the electro-optic device obtained by the manufacturing method according to claim 1.

13. An electronic apparatus comprising the electro-optic device according to claim 5.
